(19) United States
(12) Patent Application Publication
(10) Pub. No.: US 2013/0151068 A1
(43) Pub. Date: Jun. 13, 2013

(54) INFORMATION PROVIDING SYSTEM FOR VEHICLE USING SMART DEVICE

(71) Applicant: Yong Joon Lee, Hwaseong (KR)

(72) Inventor: Yong Joon Lee, Hwaseong (KR)

(73) Assignee: HYUNDAI MOTOR COMPANY, Seoul (KR)

(21) Appl. No.: 13/426,939

(22) Filed: Mar. 22, 2012

(30) Foreign Application Priority Data
Dec. 7, 2011 (KR) 10-2011-0130146

(51) Int. Cl. G06F 7/00

(52) U.S. Cl. 701/36

(57) ABSTRACT

The present invention provides an information providing system for a vehicle. The information providing system includes an information output controller, a smart device, and a stand. The information output controller receives state information from at least one vehicle state detector comprising a sensor or a switch inside the vehicle, and communicates the state information to a smart device. The smart device is loaded with an application for communicating with the information output controller and displaying the state information. The stand holds the smart device and communicably connects the smart device and the information output controller.

### CROSS-REFERENCE TO RELATED APPLICATION

This application claims under 35 U.S.C. §119(a) the benefit of Korean Patent Application No. 10-2011-0130146, filed Dec. 7, 2011, the entire contents of which are incorporated herein by reference.

### BACKGROUND

(a) Technical Field

The present invention relates to an information providing system for a vehicle. More particularly, it relates to an information providing system for a vehicle that incorporates a smart device, which can reduce the manufacturing cost for producing an instrument cluster and provide cluster information to a driver in a more optimized and unique way.

(b) Background Art

Generally, an instrument cluster is installed in front of the driver's seat of a vehicle to show the driver information related to driving and the state of various devices such as, for example, an engine, a security system, safety systems, and the like.

The information cluster is generally equipped with instruments such as, for example, a revolutions per minute (RPM) gauge, which indicates the rate of rotation of the engine, a speedometer, which indicates the driving speed, a fuel gauge, which indicates the level of remaining fuel, a thermometer, which indicates the temperature of cooling water, and a trip computer, which includes a trip meter and an odometer. The information cluster may also provide information pertaining to various kinds of indicator lamps, for example, a brake warning lamp, a seat belt warning lamp, an open door warning lamp, an ABS warning lamp, a TCS warning lamp and turn signal indicator lamps. These warning indicators function to signal the operation state and the warning state of various systems in the vehicle.

Over the past few years, the types of information to be shown on the cluster in addition to basic information have been gradually increasing due to recent advances in automobile technology, and the increased use of the high-tech convenience devices. Unfortunately, this has necessitated an increase in the complexity of the instrument cluster required to display this additional information, which has greatly increased the cost of producing an automobile.

One attempt to address this problem has been the conventional art approach of adding a liquid crystal display (LCD) to the instrument cluster to provide various kinds of graphic information. The LCD serves to provide information related to the convenience devices of a vehicle or information provided by a typical trip computer, and many studies are being conducted to display a large amount of information on the LCD 13 in an optimal layout.

Unfortunately, this conventional art approach does not solve the problem of increased manufacturing costs because the cost of installing a LCD in an instrument cluster is also high. Furthermore, a separate LCD controller for controlling the LCD is typically required, thereby increasing manufacturing costs further. Additionally, since contents displayed by the LCD are provided in accordance with user interface (UI) screen configurations or graphics that are similar to software predetermined by automobile manufacturers, the use of a manufacturer provided LCD makes it difficult for a user to be easily familiar with the graphical display of instrument cluster information, and is not well suited to allowing the user to customize the manner in which the information is displayed in order to satisfy the individual preferences of users.

Accordingly, there is a need for an improved system for displaying instrument cluster information in a vehicle that will reduce manufacturing costs and also allow users to customize how such information is displayed.

### SUMMARY OF THE DISCLOSURE

The present invention provides an information providing system for a vehicle, which can reduce the manufacturing cost for an instrument cluster, and provide instrument cluster information to a driver in a more optimized and customizable method.

In one aspect, the present invention provides an information providing system for a vehicle, including: an information output controller receiving state information from a vehicle state detector such as, for example, a sensor or a switch inside the vehicle, and a controller of a device inside the vehicle; a smart device loaded with an application for communicating with the information output controller and displaying the state information, and displaying the state information outputted from the information output controller using the application; and a stand provided to hold the smart device and communicably connecting the smart device and the information output controller while holding the smart device.

In an exemplary embodiment, the stand may be disposed in an instrument cluster.

In another exemplary embodiment, the stand may be detachably coupled to a mounting part provided in the instrument cluster.

In still another exemplary embodiment, the stand may include a cluster terminal that is automatically connected to a smart device terminal when the smart device is placed on the stand. The cluster terminal of the stand may be connected to a cluster connector for external connection. The connector of the stand may also be connected to the information output controller through the cluster connector and a cable with a terminal connector and a cluster terminal.

In yet another exemplary embodiment, the information output controller may be an instrument cluster controller.

In still yet another exemplary embodiment, the system may further include a liquid crystal display (LCD) receiving information displayed on the smart device placed on the stand and displaying the information.

In a further exemplary embodiment, the information output controller may include an interface unit provided to connect the smart device inside the vehicle to the LCD of the cluster.

In another further exemplary embodiment, the system may further include an output terminal for a vehicle configured to receive information displayed on the smart device, and displaying the information.

In still another further exemplary embodiment, the information output controller may include an interface unit provided to connect the smart device inside the vehicle to the output terminal of the vehicle.

In yet another further exemplary embodiment, the stand may include a center console terminal that is automatically connected to the smart device terminal of the smart device when the smart device is placed on the stand. The center console terminal of the stand may be connected to a center console connector for external connection. The center console connector of the stand may be connected to the interface unit through a cable.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated by the accompanying drawings, which are given hereinbelow by way of illustration only, and thus are not limitative of the present invention, and wherein:

FIG. 1 is a view illustrating a cluster equipped with a smart device in an information providing system for a vehicle according to an exemplary embodiment of the present invention;

FIG. 2 is a view illustrating a configuration of the information providing system according to an exemplary embodiment of the present invention;

FIG. 3 is a view illustrating a center console equipped with a smart device in an information providing system for a vehicle according to an exemplary embodiment of the present invention;

FIG. 4 is a view illustrating a configuration of the information providing system according to an exemplary embodiment of the present invention; and

FIG. 5 is a view illustrating a cluster controller, an LCD controller, and an LCD in a conventional art cluster.

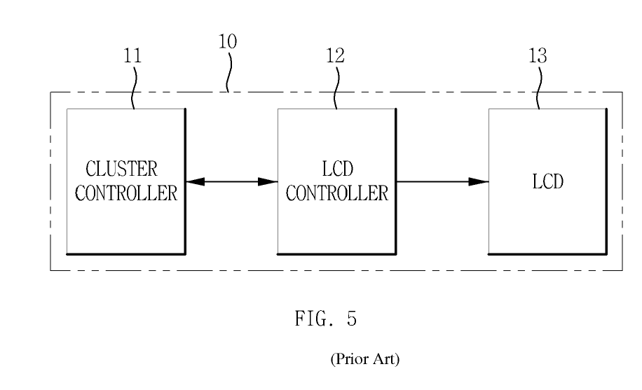

Reference numerals set forth in the Drawings includes reference to the following elements as further discussed below:

| | |
|---|---|
| 10: cluster | 11: cluster controller |
| 12: LCD controller | 12a: RPM gauge |
| 12b: speedometer | 12c: warning lamp and indicating lamp |
| 13: LCD | 14: stand |
| 15: terminal | 16: terminal |
| 17: connector | 18: interface unit |
| 20: smart device | 21: terminal |
| 22: stand | 23: terminal |
| 24: connector | 30: terminal for vehicle |
| 40: center console | 50: dashboard |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The present invention relates to an information providing system for a vehicle, which is configured to use a smart device as an auxiliary display device that displays instrument cluster information in a vehicle.

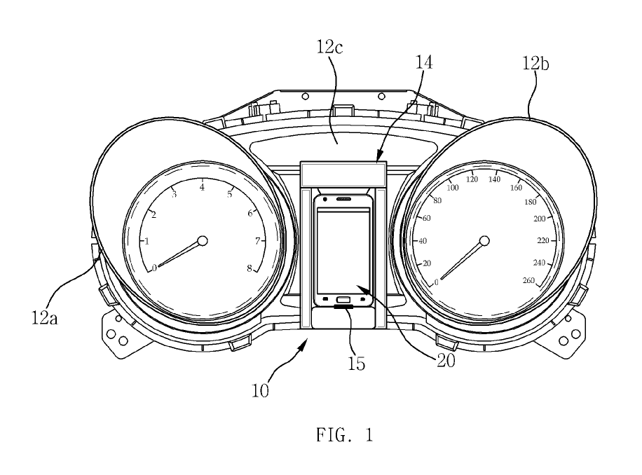

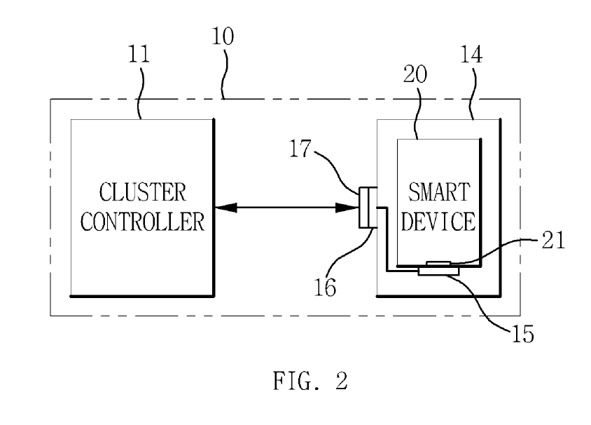

FIG. 1 is a view illustrating a cluster 10 equipped with a smart device 20 in an information providing system for a vehicle according to an exemplary embodiment of the present invention. FIG. 2 is a view illustrating an exemplary configuration of the information providing system according to the present invention.

As shown in FIG. 1, an exemplary embodiment may include a docking system in which a smart device 20 may be docked with an instrument cluster 10 in front of a driver's seat, thereby providing an auxiliary information providing system. The docking system may be mounted in the instrument cluster 10 in front of the driver's seat and may be configured to receive the smart device 20. The docking system may include a stand 14 that connects the smart device 20 and an information output controller (e.g., cluster controller) 11. The stand 14 may support the smart device 20 at a predetermined position in the instrument cluster 10 and allow communication between the smart device 20 and the information output controller 11.

As shown in FIG. 1, in an exemplary embodiment, the stand 14 may be disposed on a central mounting region of the instrument cluster 10 such as, for example, the region in which a trip computer is generally located.

The stand 14 may include a cluster terminal 15, which allows automatic connection to a smart device terminal 21 of the smart device 20. The cluster terminal 15 of the stand 14 may be connected to a terminal connector 16 for external connection through an internal cable or a circuit, and the terminal connector 16 of the stand 14 may be connected to a cluster connector 17 of the instrument cluster 10, which is connected to information output controller 11 through an internal cable connected to the connector 17.

The cluster terminal 15 of the stand 14 may be located at a place where the cluster terminal 15 of the stand 14 can be automatically connected to the smart device terminal 21 of the smart device 20 when the smart device 20 is docked with the stand 14. Accordingly, once the smart device 20 is placed on the stand 14, the smart device 20 can communicate with the information output controller 11. Accordingly, when the smart device 20 is placed on the stand 14 to enter a connectable and communicable state between smart device terminal 21 and cluster terminal 15 (i.e., a completely-docked state), information outputted from the information output controller 11 may be transmitted to the smart device 20 through applications on the smart device 20, and the information transmitted to the smart device 20 may be displayed on the screen (i.e., display device of the smart device 20) of the smart device 20.

In the information providing system according to an embodiment of the present invention, the stand 14 may hold various sizes of smart device 20, for example, different makes and models of smart devices (i.e. different manufacturers and models). Alternatively, the stand 14 may be detachably coupled to the instrument cluster 10. In this case, a user may directly couple the stand 14 fit for the size of his/her own smart device 20 to the mounting part of the instrument cluster 10. The stand 14 may be coupled to the mounting part of the instrument cluster 10 by a simple fitting method for fitting a stand in an aperture of the mounting part such as, for example, a press fitting method for forcibly inserting a stand into an aperture, or a method for mounting a stand on the mounting part using a separate coupling member. Since the stand 14 is a device for fixing the smart device 20 in a vehicle, although not shown, a locking member for locking the mounted smart device 20 may be further provided on the stand 14. Additionally, a shock-absorbing member such as a spring may be disposed on a portion of the stand 14 contacting the smart device 20 to absorb or dampen vibration and prevent the smart device 20 from shaking during vibration of a vehicle.

As shown in FIG. 1, the information providing system according to the invention may additionally include an RPM gauge 12a, a speedometer 12b, and/or an indicator light panel 12c as found in the conventional art in order to insure compliance of the vehicle with regional vehicular regulations and laws. The indicator light panel 12c may include, for example, a brake warning lamp, a seat belt warning lamp, and turn signal indicating lamp that have to be installed in the instrument cluster 10 in the form of a LED in order to meet regional legal requirements.

In addition, state information typically displayed on LCDs in the instrument cluster 10, for example, driving-related information provided by a trip computer such as trip meter and odometer, or operation state and warning state information of various kinds of devices, particularly, convenience devices in a vehicle may be collected by the information output controller 11 to be transmitted to the smart device 20 and then displayed on the smart device 20.

As shown in FIG. 2, the information output controller 11 may include an instrument cluster controller. In this case, the information output controller 11 may collect various pieces of state information to be displayed on the instrument cluster 10 from controllers of various devices such as, for example, convenience devices and vehicle state detectors such as sensors and switches in a vehicle. The state information to be displayed on the smart device 10 may be collected by the information output controller 11 to be transmitted to the smart device 20 and then displayed on the screen of the smart device 20. Thus, when the smart device 20 is docked in the stand 14, the smart device 20 and the information output controller 11 are able to communicate with each other, and various pieces of information collected by the information output controller 11 may be displayed on the smart device 20.

Applications may be executed by the smart device 20 to display information and communicate with the information output controller 11, and information transmitted from the information output controller 11 may be displayed on the applications of the smart device 20. Particularly, the information may be displayed in a configuration and graphic format selected or set by a user (i.e. the information display environment is customizable).

The applications may be provided by, for example, vehicle manufactures or application stores. For example, a user may download applications from the vehicle manufactures using the smart device 20, and may preset the information display environment, i.e., the screen configuration or graphic format of the user interface.

Recently, with rapid development of the electronic technology and information communication technology, numerous portable electronic devices are being released, and the functions of the portable electronic devices are being diversified. Particularly, since a user-oriented operating system is mounted, various kinds of smart devices such as smart phones and tablet PCs that can change, extend, and add their functions using applications provided from application stores are installed therein are being released and used. Portable smart devices such as smart phones on sale in the market may be always carried and used by a user, and may perform various functions through the simple installation of applications. Also, a user may be provided with desired forms of information by selecting and setting the screen configuration and the graphic environment of the applications optimized for the user.

According to an embodiment of the present invention, since an information providing system is configured to use a portable smart device familiar to a user as an auxiliary display device replacing a LCD in a typical cluster, a user can be provided with cluster information in a more familiar environment, and can be provided with information of unique graphics and screen configuration directly selected and configured by a user.

Also, since various kinds of information provided by expensive LCD in a typical cluster is displayed by a smart device, typical LCD and LCD controllers can be omitted from the cluster, thereby saving the manufacturing cost of a vehicle.

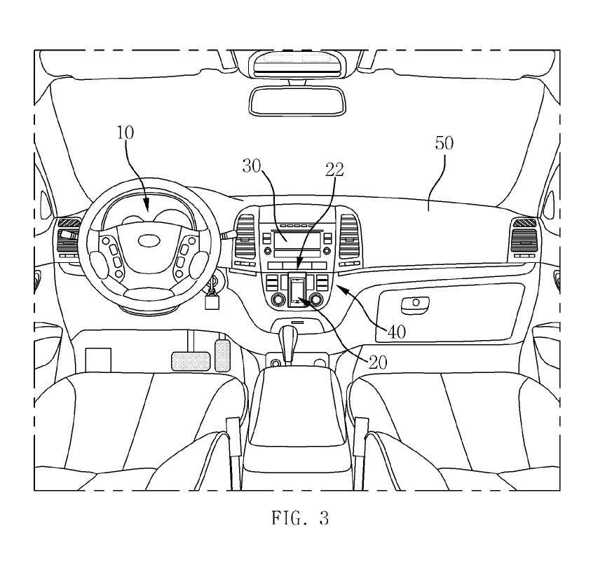

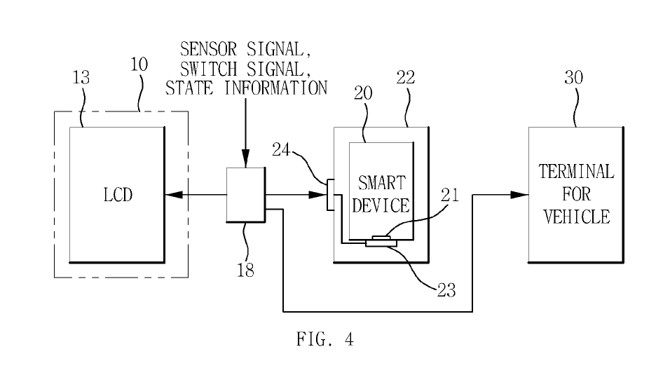

FIG. 3 is a view illustrating a center control equipped with a smart device in an information providing system for a vehicle according to an exemplary embodiment of the present invention. FIG. 4 is a view illustrating a configuration of the information providing system according to an exemplary embodiment of the present invention

As shown in FIG. 3, a smart device 20 may be located at a place other than a cluster, for example, a center console 40 or a dashboard 50.

The smart device 20 may display information as described above; however, it is also contemplated that the information may be displayed by a mirroring method in which information is simultaneously displayed on an LCD 13 in a an instrument cluster 10. The same information may be displayed on the display of the smart device 20 and the LCD 13 of the instrument cluster 10 that are synchronized with each other. In this case, a typical LCD controller may be omitted from the instrument cluster 10. Since the LCD 13 of the instrument cluster 10 serves only to output information received from the smart device 20, the LCD 13 of the instrument cluster 10 may be in linkage with the display of the smart device 20 to display the same information as the display of the smart device 20 without a separate controller. Thus, the LCD 13 of the instrument cluster 10 may display information according to the screen configuration and the graphic format of a user interface selected or set by a user through an application.

In an exemplary embodiment of the present invention, a user can verify cluster information displayed on the LCD 13 of the instrument cluster 10 by the applications of the smart device 20, and can verify the same information as the display of the smart device 20 through the LCD 13 of the instrument cluster 10.

A center console stand 22 for holding the smart device 20 may be disposed on the center console 40, the dashboard 50, or the console in general.

Although not shown, the center console stand 22 may be installed in a door opening/closing type box provided in the center console 40, and a user may open the door of the box and then place his/her smart device on the center console stand 22.

The center console stand 22 may have the same configuration previously described above. Accordingly, when the smart device 20 is docked with the center console stand 22, a center console terminal 23 of the center console stand 22 may be automatically connected to a smart device terminal 21 of the smart device 20. The center console stand 22 may include well-known stands on sale in the market, which hold the smart device 20 on the center console 40 or the dashboard 50.

A cable connected to a center console connector 24 of the center console stand 22 or a cable directly connected to the terminal of the smart device 20 may be connected to an information output unit 18 that is separated provided on an instrument panel (center console).

In this case, the information output unit 18 may be a cluster controller similar to the embodiment described above, or the information output unit 18 may be a separate interface unit that is connected to controllers of devices, sensors, or switches in a vehicle to output state information collected from the vehicle.

The information output unit 18 may be a mirroring interface unit that is connected to the LCD 13 of the instrument cluster 10 through a cable that connects the smart device 20 and the LCD 13 of the instrument cluster 10, and simultaneously may be a part that outputs state signals of various state detectors such as sensors and switches in a vehicle and information received from controllers of various devices such as convenience devices in the vehicle. Also, the information output unit 18 may be a part for inputting the state information into the smart device 20.

The information output unit 18 may be provided in the interior of a vehicle to be connected to a cable connected to the center console stand 22 or the smart device 20. When a user connects the smart device 20 to the information output unit 18, the information output unit 18 may be connected so as to transmit information to the LCD 13 of the instrument cluster 10.

Thus, when the smart device 20 is communicably connected to the information output unit 18 through a cable, the state information output through the information output unit 18 may be displayed on a display of the smart device 20 as described above.

Also, when an output terminal 30 for a vehicle such as a telematics terminal is provided in the vehicle, the output terminal 30 for the vehicle may be connected to the information output unit 18 such that information on the smart device 20 can be displayed on the output terminal 30 for the vehicle similarly to the LCD 13.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or over a Controller Area Network (CAN).

According to an embodiment of the present invention, since smart devices such as smart phones are carried and skillfully used by a driver, their use according to the invention as an auxiliary display device that displays cluster information in a vehicle will be beneficial by decreasing automotive manufacturing cost by allowing the omission of LCDs and LCD controllers, thereby increasing vehicle sales.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An information providing system for a vehicle, comprising:
at least one vehicle state detector;
an information output controller configured to receive vehicle state information from the at least one vehicle state detector; a smart device configured to communicate with the information output controller and to receive the vehicle state information from the information output controller and display the vehicle state information on the smart device; and a stand, wherein the stand provides a communication connection between the smart device and the information output controller while holding the smart device.

2. The information providing system of claim 1, wherein the stand is disposed in an instrument cluster.

3. The information providing system of claim 2, wherein the stand is detachably coupled to a mounting part provided in the instrument cluster.

4. The information providing system of claim 3, wherein:
the stand comprises a cluster terminal that is connected to a smart device terminal of the smart device when the smart device is placed on the stand; the cluster terminal of the stand is connected to a cluster connector for external connection; and the cluster connector of the stand is connected to the information output controller, thereby allowing communication between the information output controller and the smart device.

5. The information providing system of claim 1, wherein the information output controller is a cluster controller.

6. The information providing system of claim 1, further comprising an LCD.

7. The information providing system of claim 6, wherein the LCD is configured to receive information displayed on the smart device placed on the stand and display the information.

8. The information providing system of claim 1, wherein the information output controller comprises an interface unit configured to allow communication between the smart device inside the vehicle and the LCD of the instrument cluster.

9. The information providing system of claim 1, further comprising an output terminal configured to receive and display information displayed on the smart device.

10. The information providing system of claim 9, wherein the information output controller comprises an interface unit configure to connect the smart device inside the vehicle to the output terminal for the vehicle.

11. The information providing system of claim 8, wherein:
the stand comprises a cluster terminal that is connected to a smart device terminal of the smart device when the smart device is placed on the stand;
the cluster terminal of the stand is connected to a cluster connector for external connection; and
the cluster connector of the stand is connected to the information output controller, thereby allowing communication between the information output controller and the smart device.

12. The information providing system of claim 1, wherein the smart device comprises an application configured to communicate with the information output controller and graphically display information received from the information output controller on the smart device.

13. The information providing system of claim 1, wherein a driver can configure how the information received from the information output controller is displayed on the smart device.
